(19) United States
(12) Patent Application Publication
(10) Pub. No.: US 2008/0252585 A1
(43) Pub. Date: Oct. 16, 2008

(54) Outputting Apparatus

(75) Inventor: Tomoaki OKABE, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/099,443

(22) Filed: Apr. 8, 2008

(30) Foreign Application Priority Data
Apr. 13, 2007 (JP) 2007-106283

(51) Int. Cl. G09G 3/36

(52) U.S. Cl. 345/98

(57) ABSTRACT

Disclosed is an outputting apparatus connected to a plurality of external apparatus, the outputting apparatus including: a specifying section to specify the one external apparatus among the plurality of external apparatus; a storage controlling section to make a first storing section store switching information; an updating section to update switching information stored in a second storing section by making the second storing section store the switching information stored in the first storing section in a lump; a switching section to perform switching to the one external apparatus on the basis of the switching information stored in the second storing section; an output controlling section; and an inputting section, wherein the outputting controlling section performs predetermined muting processing based on the muting signal while the muting signal is being input by the inputting section to be prohibiting the outputting of the output information by the outputting section.

### BACKGROUND OF THE INVENTION

1. Field of the Invention

The present invention relates to an outputting apparatus.

2. Related Art

Outputting apparatus to output television broadcasting programs input from connected tuners or the content input from reproducing apparatus such as digital versatile disk (DVD) players have conventionally performed muting processing in order that users may not view the turbulence of images and sounds, which turbulence is produced at the time of switching external inputs or channels.

To put it concretely, for example, a television receiver was proposed which commanded the start of a video muting operation in response to channel switching operations such as the switching from a ground wave channel to another ground wave channel, the switching from a ground wave channel to the signal from external video equipment, and the switching from a ground wave channel to a satellite broadcasting wave channel, and which commanded the end of the video muting operation in response to the detection of the completion of a synchronization pulling-in operation of a video circuit when the television receiver detected the completion after the channel switching (see, for example, Japanese Patent Application Laid-Open Publication No. Hei 05-236381).

Moreover, for example, a video tape recorder and a television receiver were proposed each of which included a tuner apparatus to operate a video muting circuit and an audio muting circuit by using a signal indicating the state of being in a tuning operation at the time of channel switching as a muting pulse signal (see, for example, Japanese Patent Application Laid-Open Publication No. Hei 07-231408).

Moreover, a scramble broadcasting receiver was proposed that was provided with a muting signal generating circuit that generated a muting signal by using a broadcasting satellite (BS) channel switching signal as a trigger to release the muting signal by using the taking-in of new program information after the input of the BS channel switching signal as a trigger (see, for example, Japanese Patent Application Laid-Open Publication No. Hei 07-274084).

Moreover, a digital broadcasting receiving apparatus was proposed which performed the muting of a sound to a viewing processing section at the time of channel switching specifying and displayed a channel switching screen, and which detected the completion of decoding the sound to release the muting of the sound and to display the decoded image of the specified channel (see, for example, Japanese Patent Application Laid-Open Publication No. 2006-074241).

However, the techniques disclosed in the Japanese Patent Application Laid-Open Publications No. Hei 05-236381, No. Hei 07-274084, and No. 2006-074241 have a problem in which a muting processing time is long and a user has the feelings of uneasiness and troublesomeness because a period from a user's instruction of channel switching to the performance of an output pertaining to the instructed channel is the muting processing time.

Moreover, the technique disclosed in the Japanese Patent Application Laid-Open Publication No. Hei 07-231408 has a problem in which a muting processing time is long and a user has the feelings of uneasiness and troublesomeness because a period of performing a tuning operation is the muting processing time.

### SUMMARY OF THE INVENTION

It is an object of the present invention to eliminate the user's feelings of uneasiness and troublesomeness at the time of muting processing by shortening the muting processing time in an outputting apparatus to perform the muting processing at the time of the switching of external inputs.

According to a first aspect of the present invention, there is provided an outputting apparatus connected to a plurality of external apparatus, the outputting apparatus to output output information composed of image information and/or sound information, both input from one external apparatus among the plurality of external apparatus, the outputting apparatus comprising: a specifying section to allow a user to specify the one external apparatus among the plurality of external apparatus; a storage controlling section to make a first storing section store switching information pertaining to switching to the one external apparatus specified with the specifying section; an updating section to update switching information stored in a second storing section by making the second storing section store the switching information stored in the first storing section in a lump; a switching section to perform switching to the one external apparatus specified by the specifying section among the plurality of external apparatus on a basis of the switching information stored in the second storing section; an output controlling section to make an outputting section output the output information input from the one external apparatus switched by the switching section; and an inputting section to be inputting a muting signal to the output controlling section during a time from a start of updating of the switching information stored in the second storing section by the updating section to completion of switching to the one external apparatus specified by the specifying section by the switching section, wherein the output controlling section performs predetermined muting processing based on the muting signal while the muting signal is being input by the inputting section to be prohibiting the outputting of the output information by the outputting section.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein;

FIG. 1 is a diagram showing the functional configuration of an outputting apparatus according to the present invention; and

FIG. 2 is a diagram to illustrate the input timing of a muting signal.

### DETAILED DESCRIPTION OF THE PREFERRED EMBODIMENTS

In the following, an embodiment of the present invention will be described with reference to the attached drawings. The following descriptions pertain to the embodiment of the present invention and are not intended to limit the present invention.

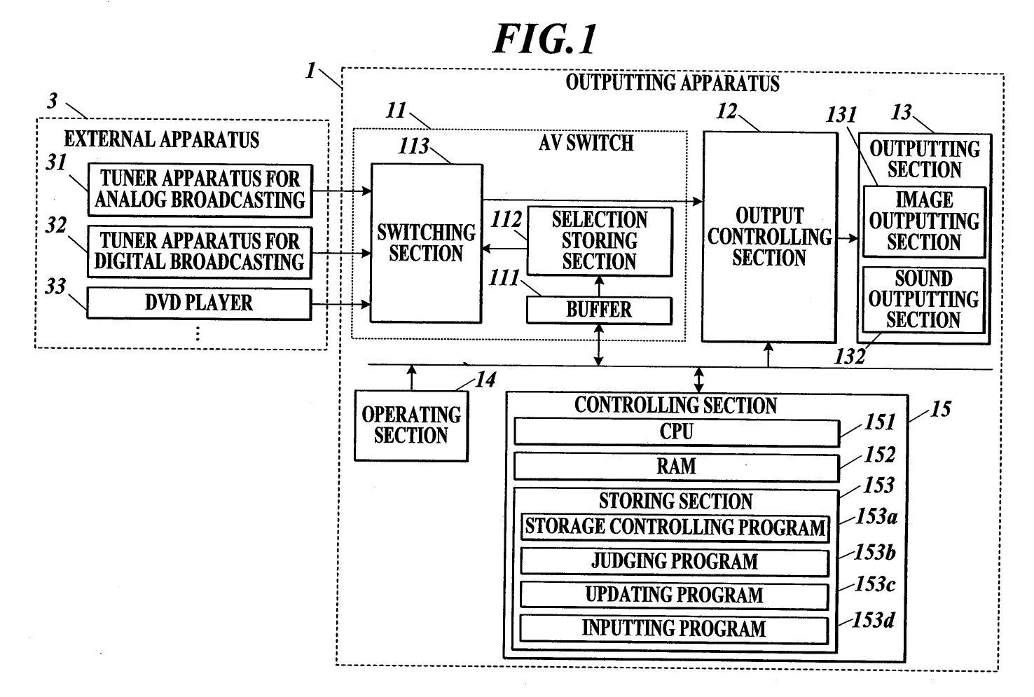

An outputting apparatus 1 is, for example, an image (video) and sound outputting apparatus incorporated in a liquid crystal television, a plasma television, or the like. For example, as shown in FIG. 1, the outputting apparatus 1 is connected to a plurality of external apparatus 3, and outputs the output information composed of image information and/or sound information that is input from one external apparatus 3 among the plurality of external apparatus 3.

The outputting apparatus 1 is connected to, for example, a tuner apparatus for analog broadcasting 31 to receive an analog broadcasting signal and to input the output information based on the analog broadcasting signal to the outputting apparatus 1, a tuner apparatus for digital broadcasting 32 to receive a digital broadcasting signal and to input the output information based on the digital broadcasting signal to the outputting apparatus 1, and a digital versatile disk (DVD) player 33 to reproduce the output information recorded on a DVD to output the reproduce output information to the outputting apparatus 1, as the external apparatus 3.

Incidentally, the external apparatus 3 are not limited to the tuner apparatus for analog broadcasting 31, the tuner apparatus for digital broadcasting 32, and the DVD player 33, but arbitrary audio visual (AV) equipment can be used as the external apparatus 3 as long as the AV equipment is the suitable equipment capable of inputting output information into the outputting apparatus 1. For example, a video recorder, a personal video recorder (PVR), a set top box (STB), a compact disc (CD) player, and an audio apparatus can be used as the external apparatus 3.

Moreover, the number of the plurality of external apparatus 3 connected to the outputting apparatus 1 is not limited to three of the tuner apparatus for analog broadcasting 31, the tuner apparatus for digital broadcasting 32, and the DVD player 33, but the number is arbitrary if at least either the tuner apparatus for analog broadcasting 31 or the tuner apparatus for digital broadcasting 32 is included and if the number is plural one.

The outputting apparatus 1 is composed of, for example, an AV switch 11, an output controlling section 12, an outputting section 13, an operating section 14, and a controlling section 15, as shown in FIG. 1.

The AV switch 11 outputs, for example, the output information input from one external apparatus 3 among the plurality of external apparatus 3 to the output controlling section 12.

To put it concretely, the AV switch 11 is composed of, for example, a buffer 111, a selection storing section 112, and a switching section 113, as shown in FIG. 1.

The buffer 111, as a first storing section, stores, for example, the switching information pertaining to the switching to the one external apparatus 3 specified by a user's operation of the operating section 14 in accordance with a control signal input from the controlling section 15.

To put it concretely, the buffer 111 sequentially stores, for example, the switching information for an image which information pertains to the switching to the image (video) input from the one external apparatus 3 specified by the user, and the switching information for a sound which image pertains to the switching to the sound input from the one external apparatus 3 specified by the user.

Moreover, the buffer 111 makes, for example, the selection storing section 112 store the switching information stored in the buffer 111 in a lump in accordance with a control signal input from the controlling section 15.

The selection storing section 112, as a second storing section, stores, for example, the switching information stored in the buffer 111 in a lump.

To put it concretely, the selection storing section 112 stores in a lump, for example, the switching information for an image, which information pertains to the switching to the image (video) input from the one external apparatus 3 specified by the user, and the switching information for a sound, which information pertains to the switching to the sound input from the one external apparatus 3 specified by the user, both pieces of information are stored in the buffer 111.

Because the pieces of the switching information are sequentially stored in the buffer 111 and are stored in the selection storing section 112 in a lump here, for example, the necessary time at the time of storing the switching information into the selection storing section 112 in order to update the switching information stored in the selection storing section 112 is shorter than the necessary time at the time of storing the switching information into the buffer 111.

The switching section 113, as a switching section, for example, switches the reception thereof to the one external apparatus 3 specified by the user's operation of the operating section 14 among the plurality of external apparatus 3 on the basis of the switching information stored in the selection storing section 112, and then the switching section 113 outputs the output information input from the switched one external apparatus 3 to the output controlling section 12.

To put it concretely, the switching section 113 switches the reception thereof to the image input from the one external apparatus 3 specified by the user among the plurality of external apparatus 3 on the basis of the switching information for an image stored in the selection storing section 112, and switches the reception thereof to the sound input from the one external apparatus 3 specified by the user among the plurality of external apparatus 3 on the basis of the switching information for a sound stored in the selection storing section 112.

The switching section 113 is configured, for example, to switch the reception thereof to the one external apparatus 3 specified by the user almost at the same time when the updating of the switching information stored in the selection storing section 112 is completed.

That is, the switching section 113 is configured, for example, to switch the image input thereof almost at the same time when the storing of the switching information for an image by the selection storing section 112 is completed, and to switch the sound input thereof almost at the same time when the storing of the switching information for a sound by the selection storing section 112 is completed. In the present invention, because the switching information stored in the selection storing section 112 is updated by making the selection storing section 112 store the switching information for an image and the switching information for a sound in a lump, the switching section 113 is led to switch the image input and the sound input thereof in a lump almost at the same time when the updating of the switching information stored in the selection storing section 112 is completed.

The output controlling section 12, as an output controlling section, outputs, for example, the output information input from the one external apparatus 3 switched by the switching section 113 to the outputting section 13 in accordance with the control signal input from the controlling section 15.

To put it concretely, the output controlling section 12 performs, for example, the predetermined processing of the output information input from the switching section 113 to separate image information, sound information, and the like, from the output information. Then, the output controlling section 12 decodes the image information to output the decoded image information to the image outputting section 131 of the outputting section 13, and decodes the sound information to output the decoded sound information to the sound outputting section 132 of the outputting section 13.

Moreover, the output controlling section 12 performs, for example, predetermined muting processing on the basis of a muting signal while the muting signal is being input by a CPU 151, which has executed an inputting program 153d, to prohibit the outputting of the output information by the outputting section 13.

To put it concretely, the output controlling section 12 is configured not to output, for example, the output information input from the switching section 113 to the outputting section 13 while the muting signal is being input.

The outputting section 13, as an outputting section outputs, for example, the output information input from the one external apparatus 3 switched by the switching section 113.

To put it concretely, the outputting section 13 is composed of, for example, the image outputting section 131 and the sound outputting section 132, as shown in FIG. 1.

The image outputting section 131 is, for example, liquid crystal display equipment, and outputs, for example, the image based on the image information input from the output controlling section 12.

The sound outputting section 132 is, for example, speaker equipment, and outputs, for example, the sound based on the sound information input from the output controlling section 12.

The operating section 14 is composed of, for example, operation buttons (not shown) provided on the external surface of the outputting apparatus 1, a remote controller (not shown) for the outputting apparatus 1, and a remote control receiving section (not shown) capable of communicating with the remote controller. For example, when the operating section 14 is operated by the user, the operating section 14 outputs various signals to accompany the operation to the controlling section 15.

To put it concretely, the operating section 14, as a specifying section, is operated, for example, when the user specifies the one external apparatus 3 among the plurality of external apparatus 3.

The controlling section 15 is composed of, for example, a central processing unit (CPU) 151, a random access memory (RAM) 152, and a storing section 153, as shown in FIG. 1.

The CPU 151 performs, for example, various controlling operations in accordance with various processing programs for the outputting apparatus 1, which processing programs are stored in the storing section 153.

The RAM 152 includes, for example, a program storing region to expand the processing programs to be executed by the CPU 151, and a data storing region to store input data and the processing results produced at the time of the execution of the processing programs.

The storing section 153 stores, for example, a system program capable of being executed in the outputting apparatus 1, various processing programs capable of being executed on the system program, the data to be used at the time of the execution of these various processing programs, and the data of the processing results of the operation processing of the CPU 151. Incidentally, the programs are stored in the storing section 153 in the forms of program codes capable of being read by a computer.

To put it concretely, the storing section 153 stores, for example, a storage controlling program 153a, a judging program 153b, an updating program 153c, and the inputting program 153d, as shown in FIG. 1.

The storage controlling program 153a enables the CPU 151 to realize, for example, the function of making the buffer 111 store the switching information pertaining to the switching to the one external apparatus 3 specified by a user's operation of the operating section 14.

To put it concretely, for example, if the switching section 113 has switched the reception thereof to the tuner apparatus for analog broadcasting 31 and the output information based on the analog broadcasting signal input from the tuner apparatus for analog broadcasting 31 is being output from the outputting section 13, and if the user operates the operating section 14 to instruct to switch the reception of the switching section 113 to the tuner apparatus for digital broadcasting 32, then the CPU 151 makes the buffer 111 sequentially stores the switching information for an image and the switching information for a sound, both indicating the switching to the tuner apparatus for digital broadcasting 32.

The CPU 151 functions as a storage controlling section by executing this storage controlling program 153a.

The judging program 153b enables the CPU 151 to realize, for example, the function of judging whether the switching information stored in the buffer 111 is correct or not.

To put it concretely, when new switching information has been stored in the buffer 111, the CPU 151 reads the switching information stored in the buffer 111 and judges whether correct switching information has been stored in the buffer 111 or not.

The CPU 151 functions as a judging section by executing this judging program 153b.

The updating program 153c enables the CPU 151 to realize, for example, the function of updating the switching information stored in the selection storing section 112 by making the selection storing section 112 store the switching information stored in the buffer 111 in a lump.

To put it concretely, if the switching information stored in the buffer 111 is judged to be correct by the CPU 151, which has executed the judging program 153b, then the CPU 151 inputs a control signal to the buffer 111 to make the selection storing section 112 store the switching information for an image and the switching information for a sound, both of which are stored in the buffer 111, in a lump, and thereby the CPU 151 updates the switching information stored in the selection storing section 112.

The CPU 151 functions as an updating section by executing this updating program 153c.

The inputting program 153d enables the CPU 151 to realize, for example, the function of being inputting a muting signal to the output controlling section 12 during a time from the start of the updating of the switching information stored in the selection storing section 112 by the CPU 151, which has executed the updating program 153c, to the completion of the switching of the reception of the switching section 113 to the one external apparatus 3 specified by a user's operation of the operating section 14 by the switching section 113.

The CPU 151 functions as an inputting section by executing this inputting program 153d.

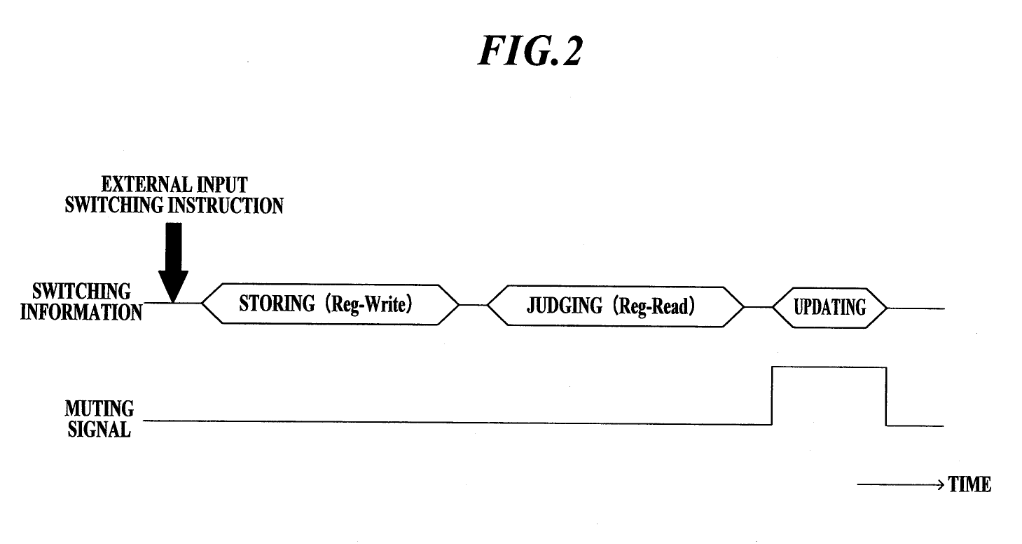

The input timing of the muting signal is described in detail here with reference to FIG. 2.

When the user first operates the operating section 14 to instruct the switching of the reception of the switching section 113 to one external apparatus 3 (for example, the tuner apparatus for digital broadcasting 32) [external input switching instruction], the CPU 151 executes the storage controlling program 153a to make the buffer 111 store the switching information pertaining to the switching of the reception of the switching section 113 to the tuner apparatus for digital broadcasting 32 specified by the user [storing (Reg-Write)].

The CPU 151 next executes the judging program 153b to judge whether the switching information stored in the buffer 111 is correct or not [judging (Reg-Read)].

When the switching information is judged to be correct by the CPU 151, which has executed the judging program 153b, the CPU 151 next executes the updating program 153c to update the switching information stored in the selection storing section 112 by making the selection storing section 112 store the switching information stored in the buffer 111 in a lump, and to make the switching section 113 switch the reception thereof to the tuner apparatus for digital broadcasting 32 specified by the user [updating]. Then, the CPU 151 executes the inputting program 153d to be inputting a muting signal to the output controlling section 12 during a time from the start of the updating of the switching information stored in the selection storing section by the CPU 151, which has executed the updating program 153c, to the completion of the switching of the reception of the switching section 113 to the tuner apparatus for digital broadcasting 32 specified by the user by the switching section 113.

Thereby, the outputting section 13 is muted only during the time from the start of the updating of the switching information stored in the selection storing section 112 to the completion of the switching by the switching section 113.

The output information input from the one external apparatus 3 (the tuner apparatus for digital broadcasting 32) specified by the user is then led to be output from the outputting section 13.

According to the outputting apparatus 1 of the present invention described above, one external apparatus 3 can be specified among the plurality of external apparatus 3 by a user's operation of the operating section 14. The switching information pertaining to the switching of the reception of the switching section 113 to the one external apparatus 3 specified by the user's operation of the operating section 14 can be stored into the buffer 111 by the CPU 151, which has executed the storage controlling program 153a. The switching information stored in the selection storing section 112 can be updated by making selection storing section 112 store the switching information stored in the buffer 111 in a lump by the CPU 151, which has executed the updating program 153c. The reception of the switching section 113 can be switched to the one external apparatus specified by the user's operation of the operating section 14 among the plurality of external apparatus 3 by the switching section 113 on the basis of the switching information stored in the selection storing section 112. The output information input from the one external apparatus 3 switched by the switching section 113 can be output to the outputting section 13 by the output controlling section 12. A muting signal can be being input into the output controlling section 12 by the CPU 151, which has executed the inputting program 153d, during the time from the start of the updating of the switching information stored in the selection storing section 112 by the CPU 151, which has executed the updating program 153c, to the completion of the switching of the reception of the switching section 113 to the one external apparatus 3 specified by the user's operation of the operating section 14 by the switching section 113. The output controlling section 12 can then perform the predetermined muting processing on the basis of the muting signal to be prohibiting the outputting of the output information by the outputting section 13 while the muting signal is being input by the CPU 151, which has executed the inputting program 153d.

That is, the muting processing time is the time from the start of the updating of the switching information stored in the selection storing section 112 to the completion of the switching of the reception of the switching section 113 to the one external apparatus 3 specified by the user. Furthermore, the selection storing section 112 is updated by storing the switching information in a lump. Consequently, the muting processing time can be shortened in comparison with the case where the period from the user's instruction of the switching of the external input to the performance of the output of the instructed external input is the muting processing time. Hence, the user's feelings of uneasiness and troublesomeness at the time of muting processing can be eliminated.

Moreover, according to the outputting apparatus 1, it can be judged whether the switching information stored in the buffer 111 is correct or not by the CPU 151, which has executed the judging program 153b. If the switching information stored in the buffer 111 is judged to be correct by the CPU 151, which has executed the judging program 153b, then the CPU 151, which has executed the updating program 153c, makes the selection storing section 112 store the switching information stored in the buffer 111 in a lump. Thereby, the switching information stored in the selection storing section 112 can be updated.

Consequently, the switching of the external input, which the user desires, can be executed accurately.

Incidentally, the present invention is not limited to the embodiment described above, but can be suitably changed without departing from the sprit and the scope of the invention.

The outputting apparatus 1 may be, for example, a television receiving apparatus formed to be in a body together with the tuner apparatus for analog broadcasting 31 and/or the tuner apparatus for digital broadcasting 32. In this case, a reproducing apparatus to reproduce the output information recorded on a predetermined recording medium, such as the DVD player 33, can be cited as the external apparatus 3.

The switching information stored in the selection storing section 112 may be updated by making the selection storing section 112 store the switching information stored in the buffer 111 without judging whether the selection storing section 112 stored in the buffer 111 is correct or not.

The entire disclosure of Japanese Patent Application No. 2007-106283 filed on Apr. 13, 2007, including description, claims, drawings, and summary are incorporated herein by reference in its entirety.

What is claimed is:

1. An outputting apparatus connected to a plurality of external apparatus, the outputting apparatus to output output information composed of image information and/or sound information, both input from one external apparatus among the plurality of external apparatus, the outputting apparatus comprising:
a specifying section to allow a user to specify the one external apparatus among the plurality of external apparatus;
a storage controlling section to make a first storing section store switching information pertaining to switching to the one external apparatus specified with the specifying section;
an updating section to update switching information stored in a second storing section by making the second storing section store the switching information stored in the first storing section in a lump;
a switching section to perform switching to the one external apparatus specified by the specifying section among the plurality of external apparatus on a basis of the switching information stored in the second storing section;
an output controlling section to make an outputting section output the output information input from the one external apparatus switched by the switching section; and
an inputting section to be inputting a muting signal to the output controlling section during a time from a start of updating of the switching information stored in the second storing section by the updating section to completion of switching to the one external apparatus specified by the specifying section by the switching section, wherein
the output controlling section performs predetermined muting processing based on the muting signal while the muting signal is being input by the inputting section to be prohibiting the outputting of the output information by the outputting section.

2. The outputting apparatus according to claim 1, further comprising a judging section to judge whether the switching information stored in the first storing section is correct or not, wherein
the updating section updates the switching information stored in the second storing section by making the second storing section store the switching information stored in the first storing section in a lump when the judging section judges that the switching information stored in the first storing section is correct.

3. An outputting apparatus connected to a plurality of external apparatus, the outputting apparatus to output output information composed of image information and/or sound information, both input from one external apparatus among the plurality of external apparatus, wherein:
the plurality of external apparatus includes at least either a tuner apparatus for analog broadcasting to receive an analog broadcasting signal to input the output information based on the analog broadcasting signal to the outputting apparatus or a tuner apparatus for digital broadcasting to receive a digital broadcasting signal to input the output information based on the digital broadcasting signal to the outputting apparatus, and
the outputting apparatus comprises:
a specifying section to allow a user to specify the one external apparatus among the plurality of external apparatus;
a storage controlling section to make a first storing section store switching information pertaining to switching to the one external apparatus specified with the specifying section;
a judging section to judge whether the switching information stored in the first storing section is correct or not;
an updating section to update switching information stored in a second storing section by making the second storing section store the switching information stored in the first storing section in a lump when the judging section judges that the switching information stored in the first storing section is correct;
a switching section to perform switching to the one external apparatus specified by the specifying section among the plurality of external apparatus on a basis of the switching information stored in the second storing section;
an output controlling section to make an outputting section output the output information input from the one external apparatus switched by the switching section; and
an inputting section to be inputting a muting signal to the output controlling section during a time from a start of updating of the switching information stored in the second storing section by the updating section to completion of switching to the one external apparatus specified by the specifying section by the switching section, wherein
the output controlling section performs predetermined muting processing based on the muting signal while the muting signal is being input by the inputting section to be prohibiting the outputting of the output information by the outputting section.
